(19) United States
(12) Patent Application Publication
(10) Pub. No.: US 2015/0289339 A1
(43) Pub. Date: Oct. 8, 2015

(54) LIGHT REGULATION METHOD, LIGHT REGULATION APPARATUS AND ADJUSTABLE LIGHT SOURCE

(71) Applicants: BOE Technology Group Co., Ltd., Beijing (CN); BOE Optical Science and Technology Co., Ltd., Suzhou (CN)

(72) Inventors: Jiefei Wu, Beijing (CN); Qingyang Zhao, Beijing (CN)

(21) Appl. No.: 14/314,536

(22) Filed: Jun. 25, 2014

(30) Foreign Application Priority Data
Apr. 3, 2014 (CN) 201410133400.X

(51) Int. Cl. H05B 33/08

(52) U.S. Cl. CPC H05B 33/0869; H05B 33/0872

(57) ABSTRACT

A light regulation method, a light regulation apparatus and an adjustable light source are provided. The light regulation method comprises: collecting environment parameter information in an illumination environment; acquiring a light regulation driving signal from the environment parameter information; and controlling at least one light emitting units on basis of the light regulation driving signal such that the at least one light emitting units work in a predetermined range of color temperature. The light regulation method, the light regulation apparatus and the adjustable light source may regulate the illumination light depending on the illumination environment to improve the comfort of the illumination.

### CROSS-REFERENCE TO RELATED APPLICATION

This application claims the benefit of Chinese Patent Application No. 201410133400.X filed on Apr. 3, 2014 in the State Intellectual Property Office of China, the whole disclosure of which is incorporated herein by reference.

### BACKGROUND OF THE INVENTION

1. Field of the Invention

The present disclosure relates to a technical field of display, more particularly, relates to a light regulation method, a light regulation apparatus and an adjustable light source.

2. Description of the Related Art

LED (light-emitting diode), due to its high luminance and low power consumption, has been becoming a primary illumination light source in place of the conventional incandescent lamp and CCFL (cold cathode fluorescent lamp) progressively.

LED illumination may achieve a relative large range of color temperature variation. Different color temperatures cause human beings to have different feelings, for example, the color temperature of below 3300K may cause a steady atmosphere and a warm feeling; the intermediate color temperature of 3000-5000K may cause a refreshing feeling; and the color temperature of above 5000K may cause a cold feeling. Thus, the variation of color temperature depending on environment temperature may achieve more comfortable illumination. The conventional light regulation or color regulation technology of the LED illumination is focused mainly on the approach for achieving the light regulation or color regulation, for example, the regulation of color temperatures or luminance values may be achieved by controlling the luminance values of the LED particles of different colors. At present, such technology or similar technology has been applied widely.

### SUMMARY OF THE INVENTION

The present disclosure provides a light regulation method, a light regulation apparatus, and an adjustable light source that may regulate the illumination light depending on the illumination environment to improve the comfort of illumination.

In order to solve the above technical problem, the present disclosure may be implemented by the following technical solutions.

According to an aspect of the present disclosure, there is provided a light regulation method comprising:

collecting environment parameter information in an illumination environment;

acquiring a light regulation driving signal from the environment parameter information; and

controlling at least one light emitting units on basis of the light regulation driving signal such that the at least one light emitting units work in a predetermined range of color temperature.

According to another aspect of the present disclosure, there is provided a light regulation apparatus comprising:

a collecting unit configured to collect environment parameter information in an illumination environment;

a processing unit configured to acquire a light regulation driving signal from the environment parameter information; and

a driving unit configured to control at least one light emitting units on basis of the light regulation driving signal such that the at least one light emitting units work in a predetermined range of color temperature.

Further, there is also provided an adjustable light source comprising at least one light emitting units and at least one light regulation apparatus described above.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative flow chart of a light regulation method according to an embodiment of the present invention;

FIG. 2 is a graph schematically showing a relationship between an environment temperature and a color temperature for illumination;

FIG. 3 is an illustrative flow chart of another light regulation method according to an embodiment of the present invention;

FIG. 4 is an illustrative view of a structure of a light regulation apparatus according to an embodiment of the present invention;

FIG. 5 is an illustrative view of a structure of another light regulation apparatus according to an embodiment of the present invention;

FIG. 6 is an illustrative view of a structure of another light regulation apparatus according to an embodiment of the present invention; and

FIG. 7 is an illustrative view of a structure of a further light regulation apparatus according to an embodiment of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

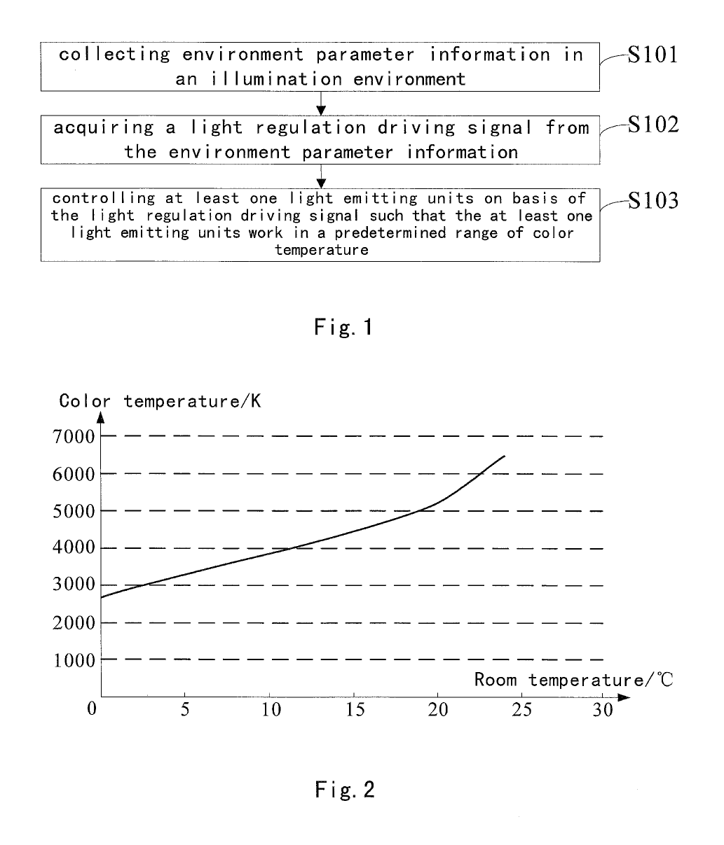

As illustrated in FIG. 1, the light regulation method according to an embodiment of the present invention comprises:

collecting environment parameter information in an illumination environment S101;

acquiring a light regulation driving signal from the environment parameter information S102; and

controlling at least one light emitting units on basis of the light regulation driving signal such that the at least one light emitting units work in a predetermined range of color temperature S103.

As an example, the environment parameter information may comprise at least one of an environment temperature, an environment humidity or an environment luminance. Users may have a feeling which varies as the color temperature of an illumination apparatus changes, for example, the color temperature of below 3300K may cause a steady atmosphere and a warm feeling; the intermediate color temperature of 3000-5000K may cause a refreshing feeling; and the color temperature of above 5000K may cause a cold feeling. By means of such variation of feeling of the users, the color temperature of the illumination apparatus may be adjusted on basis of the environment parameters, for example, when the environment temperature is relatively low or the environment humidity is relatively high, the color temperature of the light emitted from the illumination apparatus may be reduced to achieve a warm atmosphere with an intermediate humidity. As the environment temperature increases or the humidity decreases, the color temperature of the light emitted from the illumination apparatus may be improved, which can bring a relatively refreshing feeling to the people. In this way, the comfort of the illumination will be improved efficiently.

It should be noted that in the embodiments of the present invention, the environment parameter information has been explained with reference to the environment temperature. However, the environment parameter information may further comprise at least one of the environment humidity, the environment luminance or other parameters. They are not limited in the present disclosure.

As an example, acquiring a light regulation driving signal from the environment parameter information may comprise:

acquiring the light regulation driving signal by looking up a relationship table for giving the relationship between the predetermined environment parameter information and the light regulation driving signal on basis of the environment parameter information.

For example, an environment temperature signal representing the environment temperature may be collected and acquired by a temperature sensor. As an example, after the environment temperature signal is acquired, the environment temperature signal may be inputted as a control signal into a processing unit (for example a control chip). After the processing unit receives the environment temperature signal, it may find the corresponding color temperature value from the graph showing the relationship between the environment temperature and the illumination color temperature shown in FIG. 2 and further calculate out the corresponding light regulation driving signal. In the example, the graph in FIG. 2 is only a visual relationship table by way of an example. The form of the table is not limited to this.

As an example, the light emitting units may comprise a high color temperature light emitting unit and a low color temperature light emitting unit, and acquiring a light regulation driving signal from the environment parameter information may further comprise:

acquiring a high color temperature driving signal and a low color temperature driving signal from the environment parameter information, wherein the high color temperature driving signal is configured to provide a direct current to the high color temperature light emitting unit and the low color temperature driving signal is configured to provide a direct current to the low color temperature light emitting unit such that the color temperature of the mixed light of a light emitted from the low color temperature light emitting unit and a light emitted from the high color temperature light emitting unit falls within the predetermined range of color temperature.

The embodiments of the present invention are explained with reference to the LED light emitting unit. In particular, in order to achieve fine regulation of the color temperature in a certain range, warm white light particles and cold white light particles may be used as the high color temperature light emitting unit and the low color temperature light emitting unit respectively to mix colors and the regulation of the color temperature may be achieved by changing the luminance of the warm white light particles and the cold white light particles.

As an example, alternatively, the light emitting units may comprise a red light emitting unit, a green light emitting unit and a blue light emitting unit, and acquiring a light regulation driving signal from the environment parameter information may further comprise:

acquiring a red light driving signal, a green light driving signal and a blue light driving signal from the environment parameter information, wherein the red light driving signal is configured to provide a direct current to the red light emitting unit, the green light driving signal is configured to provide a direct current to the green light emitting unit and the blue light driving signal is configured to provide a direct current to the blue light emitting unit such that the color temperature of the mixed light of a light emitted from the red light emitting unit, a light emitted from the green light emitting unit and a light emitted from the blue light emitting unit falls within the predetermined range of color temperature.

In the above example, use of three colors RGB in light mixture may further improve the accuracy of color temperature control. The effects of mixing red and green (RG) are mainly used to achieve a low color temperature, the effect of blue (B) is mainly used to improve the high color temperature. The above embodiments are only by way of examples. The color temperature regulation part may further use other LED particles, which are not limited in the present disclosure.

As an example, the light regulation driving signal may comprise a pulse width modulation (PWM) signal, and in particular, controlling at least one light emitting units on basis of the light regulation driving signal comprises:

driving the least one light emitting units on basis of the pulse width modulation signal such that the respective light emitting units emit light based on a predetermined duty cycle to regulate the color temperature of the mixed light of the lights from the respective light emitting units to fall within the predetermined range of color temperature.

In an example, LED is used as an example of the light emitting units, and the temperature sensor measures the temperature of the environment in which the illumination lamp is located and transmits the measured temperature data to the processing unit. In the processing unit, on basis of the corresponding graph of the comfort of the temperature and the color temperature, a program is preset and the control signal for the color temperature and the corresponding LED modules is also preset. Different color temperature signals correspond to different PWM output ratio to control the LED modules to achieve the regulation and the variation of the color temperature. The processing unit receives the temperature signal transmitted by the temperature sensor and will perform the data process to acquire corresponding color temperature signals, and then convert the respective color temperature signals into the corresponding PWM ratio signal output. The driving unit receives the PWM ratio signal to make the LED units work under a certain current value. The special color temperature value will be acquired after color mixture of the LEDs with different colors. In the above example, with driving of the PWM signal, the fact that the respective light emitting units emit light on basis of the predetermined duty cycle may avoid too large variation of the luminance of the light emitting units efficiently while achieving color temperature variations so as to further improve the comfort of the light emitting.

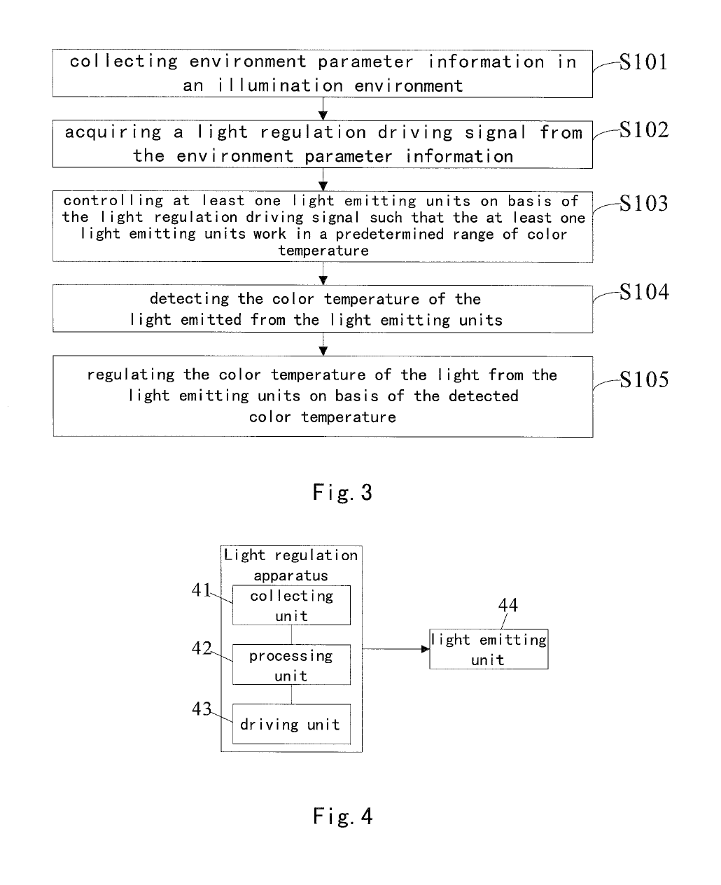

As an example, as illustrated in FIG. 3, the method may further comprise:

detecting the color temperature of the light emitted from the light emitting units S104; and

regulating the color temperature of the light emitting units on basis of the detected color temperature to keep the color temperature of the light emitting units within the predetermined range of color temperature S105.

As an example, in order to regulate and control the color temperature accurately, a color temperature sensor may be provided. The color temperature may be configured to feedback the current output color temperature to the processing unit in real-time to adjust the output current so as to achieve the color temperature which conforms to certain requirements.

The embodiments of the present invention provides a light regulation apparatus, as shown in FIG. 4, comprising:

a collecting unit 41 configured to collect environment parameter information in an illumination environment;

a processing unit 42 configured to acquire a light regulation driving signal from the environment parameter information; and

a driving unit 43 configured to control at least one light emitting units 44 on basis of the light regulation driving signal such that the at least one light emitting units work in a predetermined range of color temperature.

As an example, the environment parameter information may comprise at least one of an environment temperature, an environment humidity or an environment luminance. Users may have a feeling which varies as the color temperature of an illumination apparatus changes, for example, the color temperature of below 3300K may cause a steady atmosphere and a warm feeling; the intermediate color temperature of 3000-5000K may cause a refreshing feeling; and the color temperature of above 5000K may cause a cold feeling. By means of such variation of feeling of the users, the color temperature of the illumination apparatus may be adjusted on basis of the environment parameters. For instance, when the environment temperature is relatively low or the environment humidity is relatively high, the color temperature of the light emitted from the illumination apparatus may be reduced to achieve a warm atmosphere with an intermediate humidity. As the environment temperature increases or the humidity decreases, the color temperature of the light emitted from the illumination apparatus may be improved, which can bring a relatively refreshing to the people. In this way, the comfort of the illumination will be improved efficiently.

It should be noted that in the embodiments of the present invention, the environment parameter information has been explained with reference to the environment temperature. However, the environment parameter information may further comprise at least one of the environment humidity, the environment luminance or other parameters. They are not limited in the present disclosure.

As an example, the processing unit 42 may further be configured to further acquire the light regulation driving signal by looking up a relationship table for giving the relationship between the predetermined environment parameter information and the light regulation driving signal on basis of the environment parameter information.

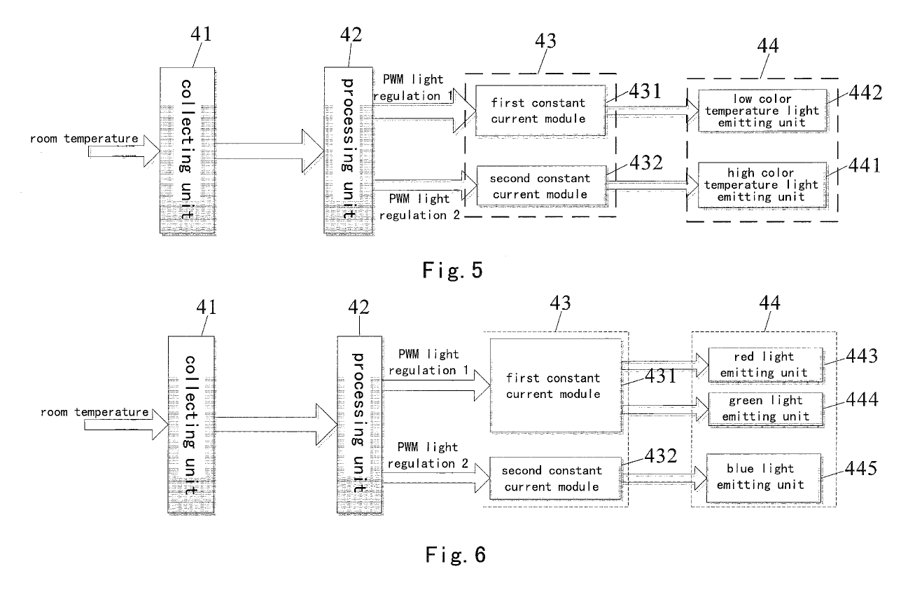

As an example, as shown in FIG. 5, the light emitting units 44 may comprise a high color temperature light emitting unit 441 and a low color temperature light emitting unit 442, and the processing unit 42 may further be configured to:

acquire a high color temperature driving signal and a low color temperature driving signal from the environment parameter information, wherein the high color temperature driving signal is configured to provide a direct current to the high color temperature light emitting unit and the low color temperature driving signal is configured to provide a direct current to the low color temperature light emitting unit such that the color temperature of the mixed light of a light emitted from the low color temperature light emitting unit and a light emitted from the high color temperature light emitting unit falls within the predetermined range of color temperature.

In an example, by way of regulating the color temperature based on the temperature, in the light regulation apparatus shown in FIG. 5, the high color temperature light emitting unit 441 and the low color temperature light emitting unit 442 may correspond to two kinds of LED chips respectively, which are a low color temperature LED chip and a high color temperature LED chip. The environment temperature (for example room temperature) signal may be acquired by a collecting unit 41, for example various known temperature sensors. The environment temperature signal is inputted as the control signal into the processing unit 42, for example a control chip. The processing unit 42 receives the environment temperature signal, and it may find the corresponding color temperature value from the graph shown in FIG. 2 and further calculate out the signal which needs to be provided to the driving unit 43. The driving unit 43 comprises two constant current modules. The PWM light regulation signal 1 and the PWM light regulation signal 2 are outputted to the first constant current module 431 and the second constant current module 432, respectively. The first constant current module 431 is configured to provide a direct current to the low color temperature chip. The second constant current module 432 is configured to provide a direct current to the high color temperature chip. The low color temperature LED chip and the high color temperature LED chip receive two groups of output currents such that two LED modules emit lights with different luminance to be mixed to form the respective color temperatures.

As an example, alternatively, as illustrated in FIG. 6, the light emitting units 44 may further comprise a red light emitting unit 443, a green light emitting unit 444 and a blue light emitting unit 445. The processing unit 42 may further be configured to:

acquire a red light driving signal, a green light driving signal and a blue light driving signal from the environment parameter information, wherein the red light driving signal is configured to provide a direct current to the red light emitting unit, the green light driving signal is configured to provide a direct current to the green light emitting unit and the blue light driving signal is configured to provide a direct current to the blue light emitting unit such that the color temperature of the mixed light of a light emitted from the red light emitting unit, a light emitted from the green light emitting unit and a light emitted from the blue light emitting unit falls within the predetermined range of color temperature.

As an example, by way of regulating the color temperature based on the temperature, in the light regulation apparatus shown in FIG. 6, the environment temperature (for example room temperature) signal is collected and acquired by the collecting unit 41 (for example temperature sensor). The environment temperature signal is inputted as the control signal into the processing unit 42, for example a control chip. The processing unit 42 receives the environment temperature signal, and it may find the corresponding color temperature value from the graph shown in FIG. 2 and further calculate out the signal which needs to be provided to the driving unit 43. The driving unit 43 comprises two constant current modules. The PWM light regulation signal 1 and the PWM light regulation signal 2 are outputted to the first constant current module 431 and the second constant current module 432, respectively. The first constant current module 431 is configured to provide direct currents to the LED-R (red light) and LED-G (green light) chips. The effect of mixing lights of the R (red light) and G (green light) chips is used to mainly achieve the low color temperature. The constant current module 432 is configured to provide a direct current to the LED-B (blue light) chip. The B (blue light) chip is used to mainly achieve the high color temperature. The LED-R (red light) chip, the LED-G (green light) chip and the LED-B (blue light) chip receive three groups of outputting currents respectively such that three LED modules emit the light with different luminance to be mixed to form the respective color temperatures.

The above embodiments are only by way of examples. The color temperature regulation part of the embodiments of the present disclosure may also use other LED particles. They are not limited in the present disclosure.

As an example, the light regulation driving signal may comprise a pulse width modulation signal, and the driving unit 13 may further be configured to:

drive the at least one light emitting units on basis of the pulse width modulation signal such that the respective light emitting units emit light based on a predetermined duty cycle to regulate the color temperature of the mixed light of the lights from the respective light emitting units to fall within the predetermined range of color temperature.

In an example, LED is used as an example of the light emitting units, and the collecting unit (for example the temperature sensor) measures the temperature of the environment in which the illumination lamp is located and transmits the measured temperature data to the processing unit. In the processing unit, on basis of the corresponding graph of the comfort of the temperature and the color temperature, a program is preset and the control signal for the color temperature and the corresponding LED modules is also preset. Different color temperature signals correspond to different PWM output ratio to control the LED modules to achieve the regulation and the variation of the color temperature. The processing unit receives the temperature signal transmitted by the temperature sensor and will perform the data process to acquire corresponding color temperature signals, and then convert the respective color temperature signals into the corresponding PWM ratio signal outputs. The driving unit receives the PWM ratio signal to make the LED units work under a certain current value. The special color temperature value will be acquired after color mixture of the LEDs with different colors. In the above example, with driving of the PWM signal, the fact that the respective light emitting units emit light on basis of the predetermined duty cycle may avoid too large variation of the luminance of the light emitting units efficiently while achieving color temperature variations so as to further improve the comfort of the light emitting.

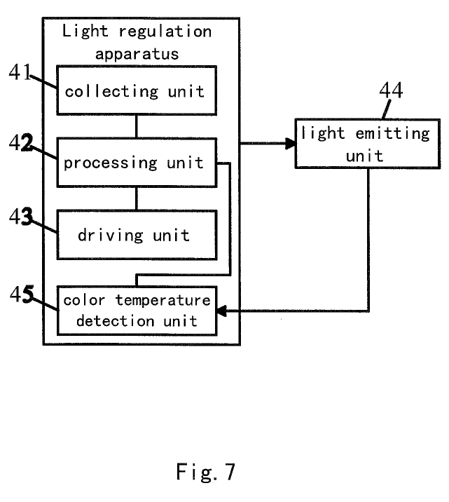

As an example, as illustrated in FIG. 7, the light regulation apparatus may further comprise a color temperature detection unit 45 configured to detect the color temperature emitted from the light emitting units 44. The processing unit 42 is further configured to regulate the color temperature of the light emitting units 44 on basis of the detected color temperature to keep the color temperature of the light emitting units within the predetermined range of color temperature.

As an example, in order to regulate and control the color temperature accurately, a color temperature sensor may be provided. The color temperature may be configured to feedback the current output color temperature to the processing unit in real-time to adjust the output current so as to achieve the color temperature which conforms to certain requirements.

An embodiment of the present disclosure also provides an adjustable light source comprising at least one light emitting units and further comprising at least one light regulation apparatus according to any one of the above examples.

The structures of the light regulation apparatus have been described in the above embodiments and thus they will be omitted below.

An embodiment of the present disclosure also provides a display apparatus comprising the adjustable light source described above.

In the embodiments of the present invention, the display apparatus may in particular comprise various known liquid crystal display apparatus or LED display apparatus.

As an example, the liquid crystal display apparatus may be any products or components having display function, such as, a liquid crystal display, a liquid crystal TV, a digital camera, a cell phone or a tablet computer. As the liquid crystal cannot emit lights by itself, the adjustable light source disclosed in the embodiments of the present invention may be used as a backlight source so as to allow the display apparatus to control the color temperature on basis of the environment parameters while providing the backlight. Alternatively, as an example, the adjustable light source provided by the embodiments of the present invention may further be used as a light emitting assembly of the LED display apparatus. The LED display apparatus may be any of the conventional LED devices. Use of the adjustable light source provided by the embodiments of the present invention as the light emitting assembly of the LED display apparatus may further allow the display apparatus to control the color temperature on basis of the environment parameters while performing color display.

The structures of the light regulation apparatus included in the adjustable light source have been described in the above embodiments and thus they will be omitted below.

The light regulation method, the light regulation apparatus, the adjustable light source and the display apparatus according to the embodiments of the present invention may collect the environment parameter information of the illumination environment, acquire the light regulation driving signals from the environment parameter information and control at least one light emitting units on basis of the light regulation driving signals such that the at least one light emitting units work in the predetermined range of the color temperature. In this way, once the environment varies, the color temperature of the light emitted from the light emitting units will change correspondingly. Thus, by means of cooperatively controlling the environment parameters and the color temperature, the lamps can change the color temperature automatically as the environment parameters change, thereby improving the matching of the illumination with the requirements of humans in the current environment temperature and improving the comfort of the light emitting.

The skilled person in the art can envisage that part of process of the above embodiments of the method may be implemented by the hardware associated with computer program instructions. The program may be stored in a computer readable storage medium. The program performs the steps comprising the above embodiments of the method when it is executed. The storage medium may comprise various media which may store program codes, such as ROM, RAM, magnet disc or optical disc.

Although several exemplary embodiments have been shown and described, the present invention is not limited to those and it would be appreciated by those skilled in the art that various changes or modifications may be made in these embodiments without departing from the principles and spirit of the disclosure, the scope of which is defined in the claims and their equivalents.

1. A light regulation method, comprising:
collecting environment parameter information in an illumination environment;
acquiring a light regulation driving signal from the environment parameter information; and
controlling at least one light emitting units on basis of the light regulation driving signal such that the at least one light emitting units work in a predetermined range of color temperature,
wherein the color temperature is adjusted to affect feeling of users in the illumination environment based on the environment parameter.

2. The light regulation method according to claim 1, wherein acquiring the light regulation driving signal from the environment parameter information comprises:
acquiring the light regulation driving signal by looking up a relationship table for giving relationship between predetermined environment parameter information and the light regulation driving signal on basis of the environment parameter information.

3. The light regulation method according to claim 1, wherein the light emitting units comprise a high color temperature light emitting unit and a low color temperature light emitting unit, and acquiring the light regulation driving signal from the environment parameter information comprises:
acquiring a high color temperature driving signal and a low color temperature driving signal from the environment parameter information, wherein the high color temperature driving signal is configured to provide a direct current to the high color temperature light emitting unit and the low color temperature driving signal is configured to provide a direct current to the low color temperature light emitting unit such that the color temperature of the mixed light of a light emitted from the low color temperature light emitting unit and a light emitted from the high color temperature light emitting unit falls within the predetermined range of color temperature.

4. The light regulation method according to claim 1, wherein the light emitting units comprise a red light emitting unit, a green light emitting unit and a blue light emitting unit, and acquiring the light regulation driving signal from the environment parameter information comprises:
acquiring a red light driving signal, a green light driving signal and a blue light driving signal from the environment parameter information, wherein the red light driving signal is configured to provide a direct current to the red light emitting unit, the green light driving signal is configured to provide a direct current to the green light emitting unit and the blue light driving signal is configured to provide a direct current to the blue light emitting unit such that the color temperature of the mixed light of a light emitted from the red light emitting unit, a light emitted from the green light emitting unit and a light emitted from the blue light emitting unit falls within the predetermined range of color temperature.

5. The light regulation method according to claim 1, wherein the light regulation driving signal comprises a pulse width modulation signal, and controlling at least one light emitting units on basis of the light regulation driving signal comprises:
driving the at least one light emitting units on basis of the pulse width modulation signal such that the respective light emitting units emit light based on a predetermined duty cycle to regulate the color temperature of the mixed light of the lights from the respective light emitting units, so as to fall within the predetermined range of color temperature.

6. The light regulation method according to claim 1, wherein the method further comprises:
detecting the color temperature of the light emitted from the light emitting units; and
regulating the color temperature of the light from the light emitting units on basis of the detected color temperature to keep the color temperature of the light emitting units within the predetermined range of color temperature.

7. The light regulation method according to claim 1, wherein the environment parameter information comprises:
at least one of an environment temperature, an environment humidity or an environment luminance.

8. A light regulation apparatus, comprising:
a collecting unit configured to collect environment parameter information in an illumination environment;
a processing unit configured to acquire a light regulation driving signal from the environment parameter information; and
a driving unit configured to control at least one light emitting units on basis of the light regulation driving signal such that the at least one light emitting units work in a predetermined range of color temperature,
wherein the color temperature is adjusted to affect feeling of users in the illumination environment based on the environment parameter.

9. The light regulation apparatus according to claim 8, wherein the processing unit is configured to further acquire the light regulation driving signal by looking up a relationship table for giving relationship between predetermined environment parameter information and the light regulation driving signal on basis of the environment parameter information.

10. The light regulation apparatus according to claim 8, wherein the light emitting units comprise a high color temperature light emitting unit and a low color temperature light emitting unit, the processing unit being further configured to:
acquire a high color temperature driving signal and a low color temperature driving signal from the environment parameter information, wherein the high color temperature driving signal is configured to provide a direct current to the high color temperature light emitting unit and the low color temperature driving signal is configured to provide a direct current to the low color temperature light emitting unit such that the color temperature of the mixed light of a light emitted from the low color temperature light emitting unit and a light emitted from the high color temperature light emitting unit falls within the predetermined range of color temperature.

11. The light regulation apparatus according to claim 8, wherein the light emitting units comprise a red light emitting unit, a green light emitting unit and a blue light emitting unit, the processing unit being further configured to:
acquire a red light driving signal, a green light driving signal and a blue light driving signal from the environment parameter information, wherein the red light driving signal is configured to provide a direct current to the red light emitting unit, the green light driving signal is configured to provide a direct current to the green light emitting unit and the blue light driving signal is configured to provide a direct current to the blue light emitting unit such that the color temperature of the mixed light of a light emitted from the red light emitting unit, a light emitted from the green light emitting unit and a light emitted from the blue light emitting unit falls within the predetermined range of color temperature.

12. The light regulation apparatus according to claim 8, wherein the light regulation driving signal comprises a pulse width modulation signal, the driving unit being further configured to:
drive the at least one light emitting units on basis of the pulse width modulation signal such that the respective light emitting units emit light based on a predetermined duty cycle to regulate the color temperature of the mixed light of the lights from the respective light emitting units, so as to fall within the predetermined range of color temperature.

13. The light regulation apparatus according to claim 8, wherein the light regulation apparatus further comprises:
a color temperature detection unit configured to detect the color temperature of the light emitted from the light emitting units; and
wherein the processing unit is further configured to regulate the color temperature of the light from the light emitting units on basis of the detected color temperature to keep the color temperature of the light emitting units within the predetermined range of color temperature.

14. The light regulation apparatus according to claim 8, wherein the environment parameter information comprises:
at least one of an environment temperature, an environment humidity or an environment luminance.

15. An adjustable light source, comprising at least one light emitting units, wherein the adjustable light source further comprises at least one light regulation apparatus, wherein the light regulation apparatus comprises:
a collecting unit configured to collect environment parameter information in an illumination environment;
a processing unit configured to acquire a light regulation driving signal from the environment parameter information; and
a driving unit configured to control at least one light emitting units on basis of the light regulation driving signal such that the at least one light emitting units work in a predetermined range of color temperature,
wherein the color temperature is adjusted to affect feeling of users in the illumination environment based on the environment parameter.

16. The adjustable light source according to claim 15, wherein the processing unit is configured to further acquire the light regulation driving signal by looking up a relationship table for giving relationship between predetermined environment parameter information and the light regulation driving signal on basis of the environment parameter information.

17. The adjustable light source according to claim 15, wherein the light emitting units comprise a high color temperature light emitting unit and a low color temperature light emitting unit, the processing unit being further configured to:
acquire a high color temperature driving signal and a low color temperature driving signal from the environment parameter information, wherein the high color temperature driving signal is configured to provide a direct current to the high color temperature light emitting unit and the low color temperature driving signal is configured to provide a direct current to the low color temperature light emitting unit such that the color temperature of the mixed light of a light emitted from the low color temperature light emitting unit and a light emitted from the high color temperature light emitting unit falls within the predetermined range of color temperature.

18. The adjustable light source according to claim 15, wherein the light emitting units comprise a red light emitting unit, a green light emitting unit and a blue light emitting unit, the processing unit being further configured to:
acquire a red light driving signal, a green light driving signal and a blue light driving signal from the environment parameter information, wherein the red light driving signal is configured to provide a direct current to the red light emitting unit, the green light driving signal is configured to provide a direct current to the green light emitting unit and the blue light driving signal is configured to provide a direct current to the blue light emitting unit such that the color temperature of the mixed light of a light emitted from the red light emitting unit, a light emitted from the green light emitting unit and a light emitted from the blue light emitting unit falls within the predetermined range of color temperature.

19. The adjustable light source according to claim 15, wherein the light regulation driving signal comprises a pulse width modulation signal, the driving unit being further configured to:
drive the at least one light emitting units on basis of the pulse width modulation signal such that the respective light emitting units emit light based on a predetermined duty cycle to regulate the color temperature of the mixed light of the lights from the respective light emitting units, so as to fall within the predetermined range of color temperature.

20. The adjustable light source according to claim 15, wherein the light regulation apparatus further comprises:
a color temperature detection unit configured to detect the color temperature of the light emitted from the light emitting units; and
wherein the processing unit is further configured to regulate the color temperature of the light from the light emitting units on basis of the detected color temperature to keep the color temperature of the light emitting units within the predetermined range of color temperature.
